(19) United States
(12) Patent Application Publication
(10) Pub. No.: US 2002/0087720 A1
(43) Pub. Date: Jul. 4, 2002

(54) System and method for communications management and control over an unreliable communications network

(76) Inventors: Arlin R. Davis, Yamhill, OR (US); Mark S. Hefty, Aloha, OR (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/749,384

(22) Filed: Dec. 28, 2000

(51) Int. Cl. G06F 15/173; G06F 15/16

(52) U.S. Cl. 709/238; 709/234

(57) ABSTRACT

A system, method and computer program to enable the transmission and reception of messages between nodes in a communications network. This system, method and computer program operate using a flow control message header having a message sent field and a message limit field. The message limit field would indicate the maximum number of messages a transmitting node may send to a receiving node. The message sent field would indicate the number of messages that have been sent. By using these field and keeping track of the messages sent and received it is possible for this system, method and computer program to insure that a receiving node has adequate memory space to receive messages and to identify when a message is dropped during a transmission and provide additional memory space to compensate for such a dropped message.

### FIELD

The invention relates to a system and method for communications management and control over an unreliable communications network.

### BACKGROUND

In the rapid development of computers many advancements have been seen in the areas of processor speed, throughput, communications, and fault tolerance. Initially computer systems were standalone devices in which a processor, memory and peripheral devices all communicated through a single bus. Later, in order to improve performance, several processors and were interconnected to memory and peripherals using one or more buses. In addition, separate computer systems were linked together through different communications mechanisms such as, shared memory, serial and parallel ports, local area networks (LAN) and wide area networks (WAN). However, these mechanisms have proven to be relatively slow and subject to interruptions and failures when a critical communications component fails.

However, no matter what type of architecture is utilized, the classic problem found in communications is determining if the receiver has the capability of receiving an entire message at any given moment in time and that the entire message was actually received by a particular receiver. One method utilized in the past to assure a sender that the receiver has the capacity to receive messages involved the transmission of tokens from the receiver to the sender. This mechanism was known as an absolute credit update method. In this absolute credit update method the potential receiver message would, for example, transmit three tokens to a potential sender. These three tokens would indicate that the receiver is able to receive three packets or chunks of data representing one or more messages. The sender would then send these three pieces of information to the receiver. Thereafter, the receiver would then transmit additional tokens indicating the ability to receive additional information.

The problem encountered utilizing this absolute credit method was that a highly reliable communications fabric or network is assumed to exist. No provision exists in the absolute credit update method for detection of lost packets or pieces of information or messages. However, as previously discussed, failures in hardware occur and information transmitted over a network may be lost in the transmission process. Mechanisms do exist for lost packets recovery. However, these mechanisms very often are complex and utilize a significant amount of the communications bandwidth available simply for detection of lost information. Therefore, the existing mechanisms for lost information detection and recovery do not allow a network to fully utilize the bandwidth capability available to it.

Therefore, what is needed is a method and computer program that will determine if a potential receiver of a message has the capability of receiving that message at a given point in time. Further, this method and computer program must be able to detect when a lost message or data has occurred. This method and computer program for detection of a lost message must be simple to implement and execute and utilize minimum processor time as well as communications bandwidth. Therefore, this method and computer program must be able to keep communications speed as close to the bandwidth limit as possible.

### BRIEF DESCRIPTION OF THE DRAWINGS

The foregoing and a better understanding of the present invention will become apparent from the following detailed description of exemplary embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and the invention is not limited thereto. The spirit and scope of the present invention are limited only by the terms of the appended claims.

The following represents brief descriptions of the drawings, wherein:

FIG. 1 is an example of an overall InfiniBand systems diagram which may be used by the example embodiments of the present invention;

FIG. 2 is an example of a software layer diagram used in the example embodiments of the present invention;

FIG. 3 is an example of a flow control message header used in the example embodiments of the present invention;

FIG. 4 is an example flowchart for the Post Send module used in the example embodiments of the present invention;

FIG. 5 is an example flowchart for the Get Credit module used in the example embodiments of the present invention;

FIG. 6 is an example flowchart for the Periodic Update module used in the example embodiments of the present invention;

FIG. 7 is an example flowchart for the Receive Done module used in the example embodiments of the present invention;

FIG. 8 is an example flowchart for the Post Receive module used in the example embodiments of the present invention; and

FIG. 9 is an example flowchart for the Threshold Check module used in the example embodiments of the present invention.

### DETAILED DESCRIPTION

Before beginning a detailed description of the subject invention, mention of the following is in order. When appropriate, like reference numerals and characters may be used to designate identical, corresponding or similar components in differing figure drawings. Further, in the detailed description to follow, exemplary sizes/models/ values/ranges may be given, although the present invention is not limited to the same. As a final note, well-known components of computer networks may not be shown within the FIGS. for simplicity of illustration and discussion, and so as not to obscure the invention.

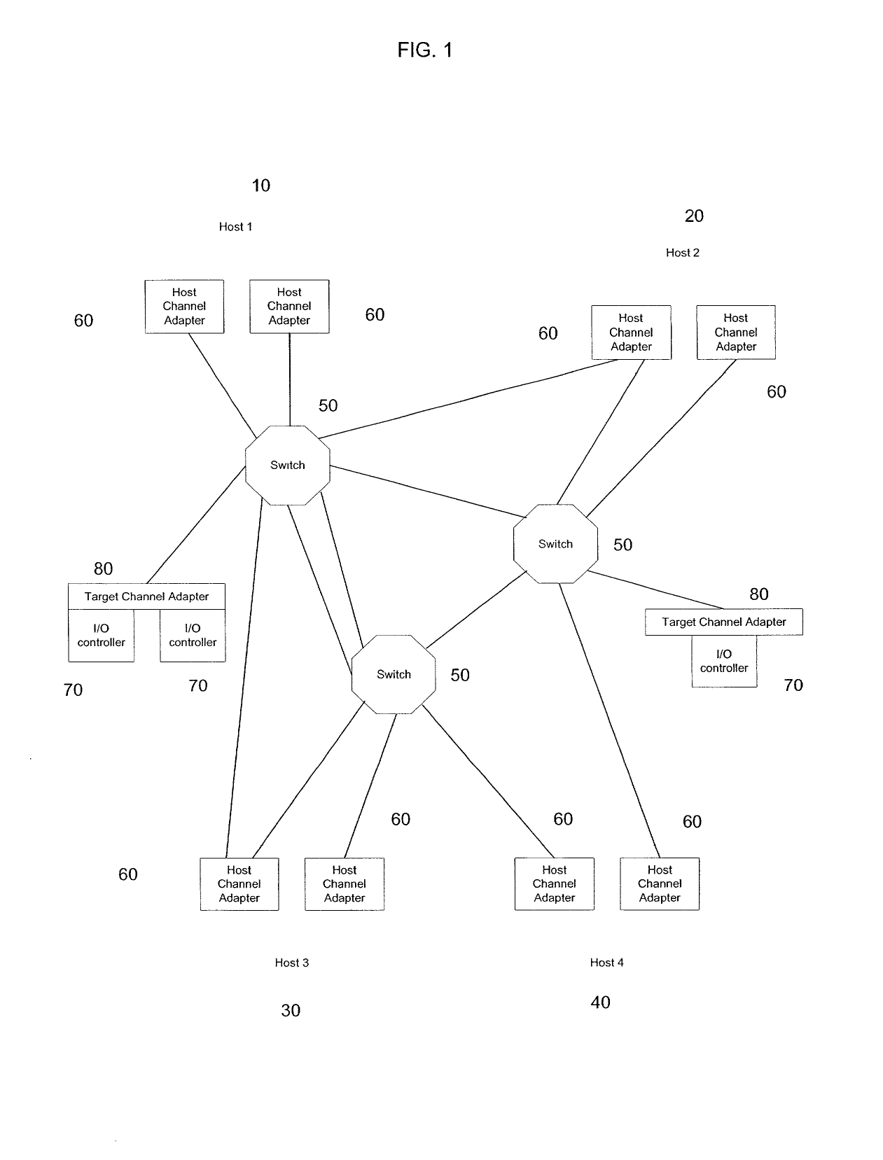

FIG. 1 is an example of an overall InfiniBand systems diagram which may be used by the embodiments of the present invention. Using such an InfiniBand architecture it may be possible to link together a processor based system 10, through switches 50 to several Input/Output (I/O) controllers 70, and other processor based systems 20, 30 and 40. Each processor based system 10, 20, 30 and 40 may be composed of one or more central processing units (CPU) (not shown), dynamic random access memory (DRAM) (not shown), memory controller (not shown) and a host channel adapter (HCA) 60. I/O controllers 70 communicate to the InfiniBand network or fabric via target channel adapters (TCA) 80. These I/O controllers 70 may be used to communicate to peripheral devices, such as, but not limited to, mass storage units and printers. Further, these I/O controllers 70 may also interface to other local area networks (LAN) or wide area networks (WAN). A switch 50 may be used to interconnect serial ports to achieve transfer rates of more than one gigabit-per-second. In addition, a host channel adapter 60 may be directly connected to a target channel adapter 80 or another host channel adapter 60.

Referring to FIG. 1, the InfiniBand architecture defines interfaces that move data between two “memory” regions or nodes. Access to an I/O controller 70 and processor based systems 10, 20, 30 and 40, may be accomplished by send or receive operations, as well as, remote direct memory access (RDMA) read and RDMA write operations. Cluster, channel adapters 60 and target channel adapters 80 provide the control and logic that allows nodes to communicate to each other over the InfiniBand network or fabric. A processor based system 10, 20, 30 or 40 may have one or more channel adapters 60 connected to it. Further, an I/O controller 70 may have one or more target channel adapters 80 connected to it. Communications in an InfiniBand architecture may be accomplished through these cluster, host channel adapters 60, target channel adapters 80 directly or through switches 50.

As can be seen in FIG. 1, the InfiniBand architecture enables redundant communications links between host channel adapters 60, target channel adapters 80, and switches 50. Further, it may be possible to create a routing and distance table to identify the shortest paths between nodes in the network. In this case, distance is defined as being the shortest time between two points and not the physical distance. A node or cluster adapter may be a host channel adapter 60 or a target channel adapter 80. Therefore, when data is sent to a memory location in a node it will take the shortest path available and arrive as fast as possible. However, if a failure occurs to a switch 50 then an alternate path may have to be configured and the distance table would have to be computed again.

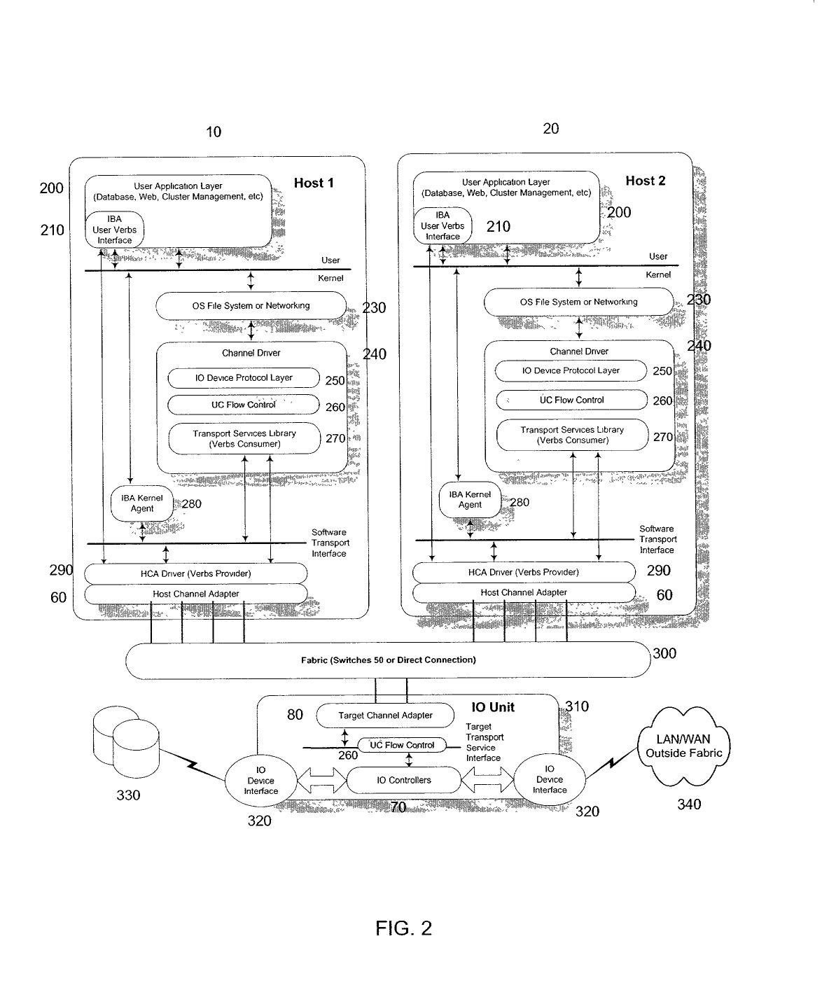

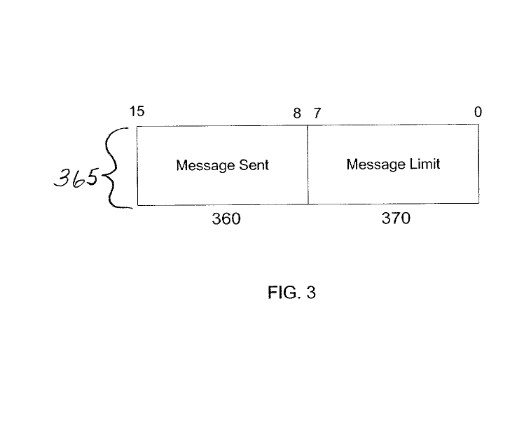

Before proceeding into a detailed discussion of the logic used by the present invention it should be mentioned that the software layer diagram shown in FIG. 2 and the flowcharts shown in FIGS. 3 through 9 contain software, firmware, hardware, processes or operations that correspond, for example, to code, sections of code, instructions, commands, objects, hardware or the like, of a computer program that is embodied, for example, on a storage medium such as floppy disk, CD-Rom (Compact Disc read-only Memory), EP-Rom (Erasable Programmable read-only Memory), RAM (Random Access Memory), hard disk, etc. Further, the computer program can be written in any language such as, but not limited to, for example C++.

FIG. 2 is an example of a software layer diagram used in the example embodiments of the present invention. Four major components are illustrated in FIG. 2. The first two major components comprise a processor 10 and processor 20. Both processor 10 and processor 20 are identical. Both processor 10 and processor 20 have a user application layer 200 which may include, but not limited to, database, web access, cluster management or other such functions. Embedded within user application layer 200 is an InfiniBand architecture (IBA) module 210 containing user verbs and interfaces. The next layer of software crosses the line between user applications and the operating system (O/S) kernel. This includes an operating system file system or network 230 which interfaces to a channel driver 240. Within the channel driver 240 may be found an I/O device protocol layer 250, a flow control module 260, and a transport service library 270. The embodiments of the present invention may reside in, but are not limited to, the flow control module 260. Further, the user or application layer 200 may bypass the OS file system 230 and channel driver 240 by using an IBA kernel agent 280. However, whether through the IBA kernel agent 280 or the channel driver 240 communications must go through the host channel adapter (HCA) driver 290 which in turn interfaces to HCA 60.

Still referring to FIG. 2, communications between the HCA 60 and TCA 80 in I/O units 310 would occur over the InfiniBand fabric 300. The InfiniBand fabric 300 would be either switches 50 or a direct serial connection between HCA 60 and TCA 80. Besides TCA 80 I/O units 310 would also include a corresponding flow control module 260 in which the embodiments of the present invention may reside but are not limited thereto. Further, I/O units 310 would include I/O controller 70 which would interface to I/O device interface 320. I/O device interface 320 would include, but not limited to, items such as mass storage controllers and other parallel or serial communications interfaces. In turn, I/O device interface 320 may interface to mass storage devices 330 or an outside LAN or WAN network 340.

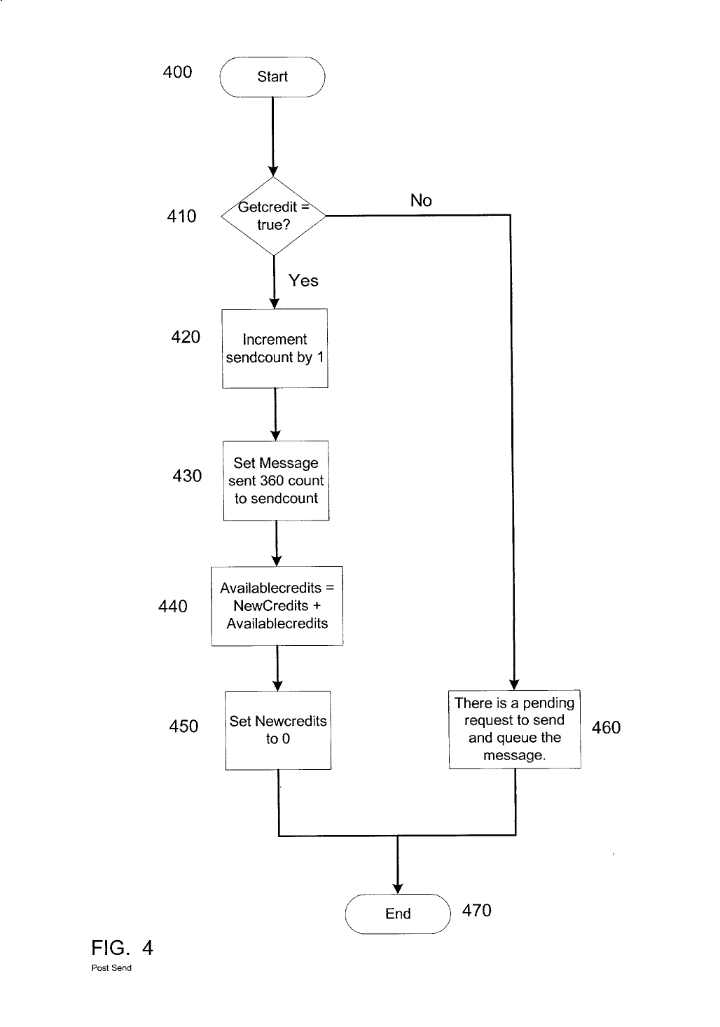

FIG. 3 is an example of a flow control message header 365 used in the example embodiments of the present invention. This flow control message header 365 may be transmitted with applications send messages or as a separate message. The flow control message header 365 has two components. The first components is the message sent 360 which indicates the total number of messages sent by the initiating or transmitting processor. The second component is the message limit 370 which represents the total number of messages that the remote node may send over the connection. As will become evident from the discussion of FIGS. 4-9 by utilizing message sent 360 and message limit 370 it is possible to guarantee that a receiving processor of a message will have required message buffer to store the message. Further, utilizing message sent 360 and message limit 370 it would possible to detect lost messages or pieces of data.

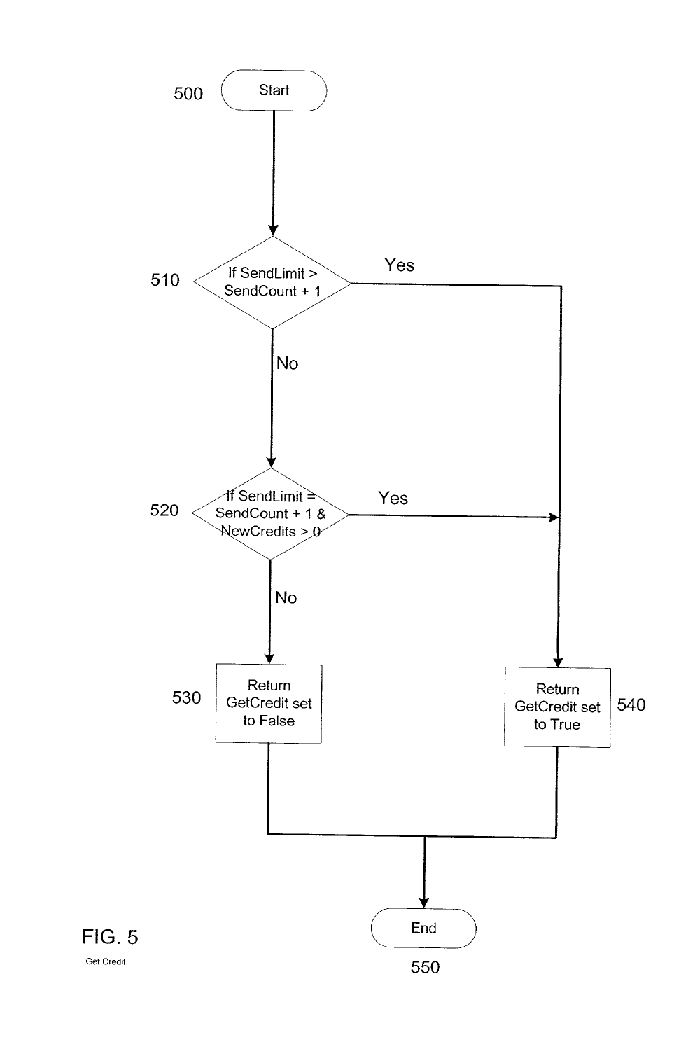

FIG. 4 is an example flowchart for the Post Send module used in the example embodiments of the present invention. The post send module begins execution in operation 400 and immediately proceeds to operation 410. In operation 410 it is determined whether the variable get credit has been set to true by the get credit module, discussed in further detail in reference to FIG. 5. If the variable get credit is true then this would indicate that the receiving node has allocated memory space for messages sent by the transmitting node. If the variable get credit is not true then processing proceeds to operation 460. In operation 460, it is determined that there is a pending request to send a message and that the message must be queued for later transmission. Thereafter, processing proceeds to operation 470 where processing terminates.

Still referring to FIG. 4, if the variable get credit is set to true, then processing proceeds to operation 420 where the variable send count is incremented by one. The variable send count is incremented for each message sent and used to update the message sent 360 field of the flow control message header 365 previously discussed in reference to FIG. 3. In operation 430, the message sent 360 field of the flow control message header 365 is set equal to the variable send count. Thereafter, in operation 440 the variable available credits is set equal to the variable new credits plus the variable available credits. The variable available credits is the number of messages available on the receiving work queue in the receiving processor that have been allocated to the transmitting processor. The variable available credits is used to manage the credit update threshold and is initialized to the amount of messages posted during a connection session. Further, the variable available credits is decremented for each message received or lost. New credits is a variable that represents credits not yet given to the transmitting processor. The variable new credits is incremented for each new message posted on a received queue. Thereafter, processing proceeds to operation 450 where the variable new credits is set to zero. Processing then proceeds to operation 470 where processing terminates.

FIG. 5 is an example flowchart for the Get Credit module used in the example embodiments of the present invention. The get credit module begins execution in operation 500 and immediately proceeds operation 510. In operation 510, it is determined whether the variable send limit is greater than the variable send count incremented by one. The variable send limit is the maximum number of messages that may be sent to a remote receiving queue in a remote processor. Further, the variable send limit would include the number of messages sent by the transmitting node plus the number of received buffers still available in the remote receiving processor node. If the variable send limit is greater than the variable send count incremented by one then processing proceeds to operation 540. In operation 540 the variable get credit is set to true. Thereafter, processing proceeds operation 550 where processing terminates.

Still referring to FIG. 5, if the variable send limit is less than or equal to the variable send count incremented by one then processing proceeds to operation 520. In operation 520, it is determined if the variable send limit is equal to the variable send count plus one and that the variable new credits is greater than zero. If the variable send limit is equal to the variable send count plus one and the variable new credits is greater than zero then processing proceeds operation 540 as previously discussed. However, if the variable send limit is not equal to the variable send count plus one and new credits is not greater than zero then processing proceeds operation 530. In operation 530, the variable get credit is set false and processing proceeds operation 550 where processing terminates.

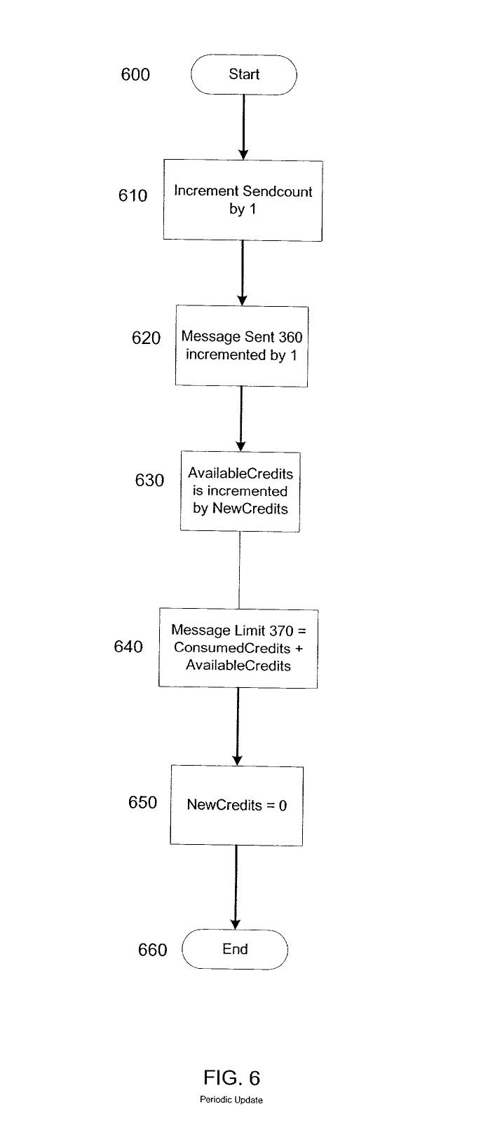

FIG. 6 is an example flowchart for the Periodic Update module used in the example embodiments of the present invention. The periodic update module begins execution in operation 600 and immediately proceeds to operation 610. In operation 610 the variable send count is incremented by one. Thereafter, in operation 620 message sent 360 field of the flow control message header 365 is incremented by one. In operation 630 variable available credits is incremented by the value contained in the variable new credits. Thereafter, in operation 640 the message limit 370 field of the flow control message header 365 is set equal to the variable consumed credits plus the variable credits. The variable consumed credits is the total number of messages that were either received or lost. The variable consumed credits is initially set to zero during a connection session and is incremented for each received or dropped message. Further, the variable consumed credits is in each used to update the message limit field 370 of the flow control message header 365. In operation 650 the variable new credits is set to zero and processing terminates in operation 660.

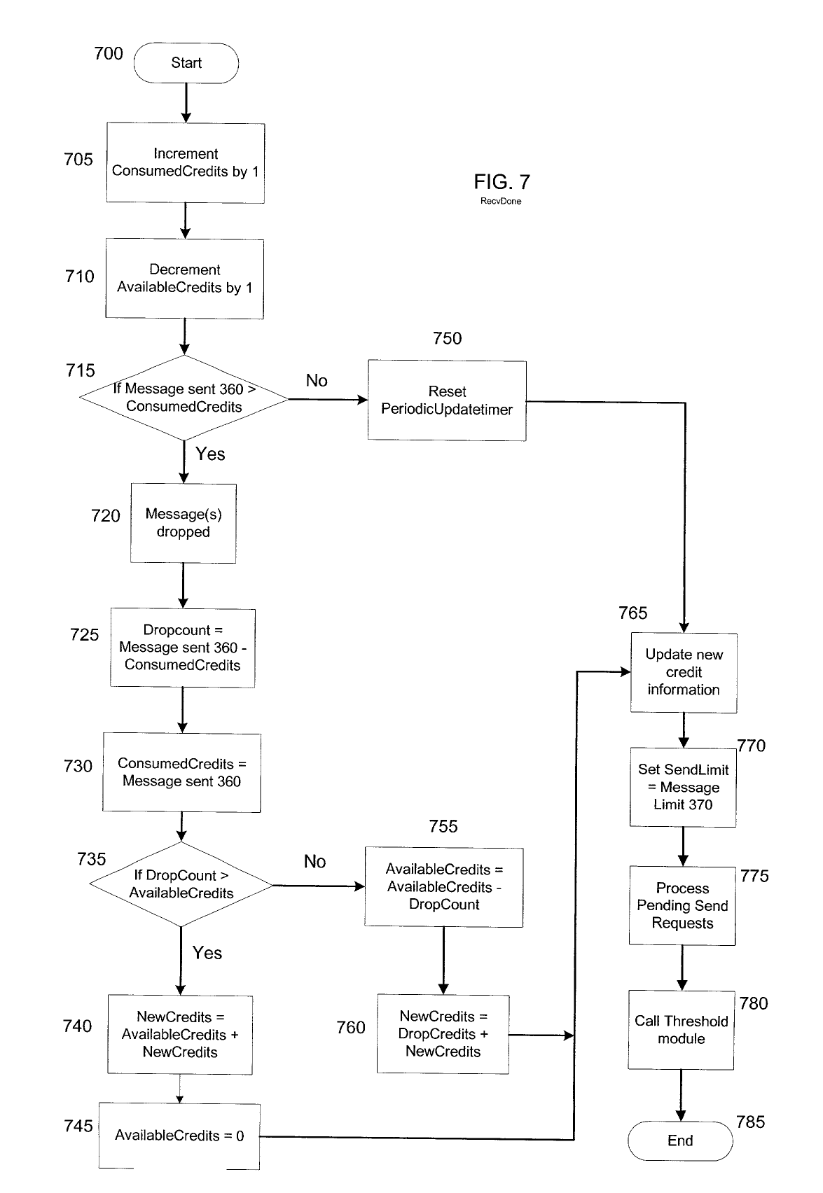

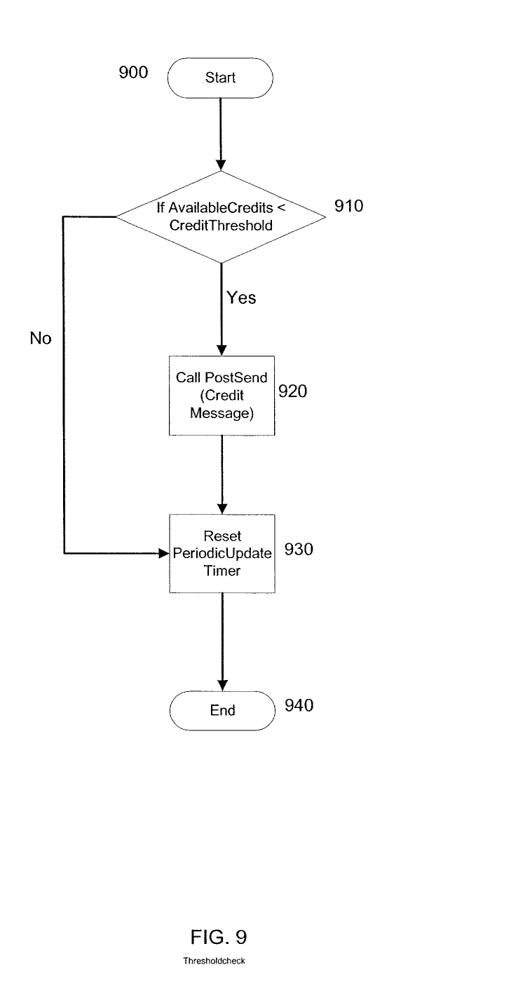

FIG. 7 is an example flowchart for the Receive Done module used in the example embodiments of the present invention. The Receive Done module begins execution in operation 700 and immediately proceeds to operation 705. In operation 705, the variable consumed credits is incremented by one. Thereafter, in operation 710 the variable available credits is incremented by one. In operation 715, it is determined whether the message sent 360 field of the flow control message header 365 is greater than the value contained in the variable consumed credits. If in operation 715 it is determined that the value contained in the message sent 360 field is not greater than the value contained in the variable consumed credits then processing proceeds to operation 750. Branching to operation 750 would indicate that no message or piece of data was dropped during transmission. In operation 750 the periodic update timer is reset. This periodic update timer serves to prevent blockages from forming between communicating parties where we due to some failure or error a transmitting party has run out of credits. The periodic update timer will be further discussed in reference to periodic update timer module illustrated in FIG. 9.

However, if in operation 715 it is determined that the message sent 360 field in the flow control message header 365 is less than or equal to the value contained in the variable consumed credits then processing proceeds to operation 720 where it is presumed that a message or piece of data has been dropped during transmission. In operation 725, a variable drop count is set equal to the message sent 360 in the field flow control message header 365 less the variable consumed credits. The variable consumed credit is the total amount of messages received or dropped. This consumed credits variable is initialized to zero when a communications connection is established. Thereafter, in operation 735 it is determined if the variable drop count is greater than the variable available credits. As previously discussed, the variable available credits is the number of messages or space available on a received work queue that have been allocated for a transmitting processor to send messages to. If the value contained in the variable drop count is greater than the value contained the variable available credits then processing proceeds to operation 740. In operation 740 the variable new credits is incremented by the variable available credits. Thereafter, processing proceeds operation 745 with the variable available credits is set to zero. Processing then proceeds to operation 765 where the new credit information is updated. In operation 770, a variable send limit is set equal to the message limit 370 in the flow control message header 365. In operation 775, processing of any pending send request then proceeds. Thereafter, in operation 780 the threshold module is then activated and thereafter processing terminates in operation 785.

Still referring to FIG. 7, if in operation 715 it is determined that the message sent to 360 field contains a value that is not greater than the variable consumed credits then processing proceeds to operation 750 as previously discussed. In operation 750, the periodic update timer is reset. Thereafter, processing proceeds operates 765 as previously discussed.

Still referring to FIG. 7, if in operation 735 it is determined that the variable drop count has a value which is equal to or less than the variable available credits then processing proceeds operation 755. In operation 755 the variable available credits is decremented by the value contained in the variable drop count. Thereafter, processing proceeds to operation 760. In operation 760, the variable new credit is incremented by the variable drop credits. Processing then proceeds to operation 765 as previously discussed.

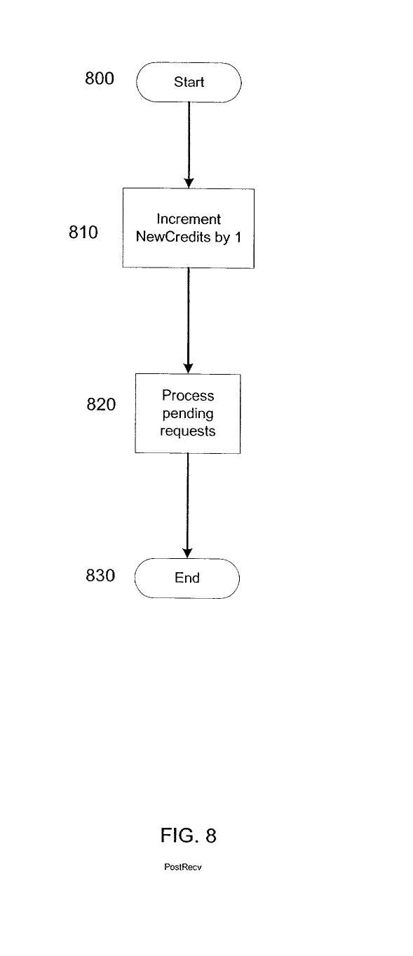

FIG. 8 is an example flowchart for the Post Receive module used in the example embodiments of the present invention. The Post Receive module begins execution in operation 800 and immediately proceeds to operation 810. In operation 810 the variable new credits is incremented by one. In operation 820 any pending request for messages are processed. Thereafter, in operation 830 processing terminates.

FIG. 9 is an example flowchart for the Threshold Check module used in the example embodiments of the present invention. The Threshold Check module begins execution in operation 900 and immediately proceeds to operation 910. In operation 910 it is determined whether the variable available credits is less then the value contained in a variable credit threshold. The variable credit threshold is a counter used to limit the number of credit updates and ensures that credit updates are provided for unidirectional traffic patterns. If the value contained in the variable available credits is greater than or equal to the value contained in the variable credits threshold then processing proceeds to operation 930 as will be discussed in further detailed ahead. However, if the value contained in the variable available credits is less than the value contained in the variable credit threshold then processing proceeds operation 920. In operation 920 the Post Send module, discussed in reference to FIG. 4, is executed so that a credit message is sent to the transmitting node or processor in order to update the number of credits available to that processor. Thereafter, processing proceeds to operation 930 where the periodic update timer module, previously discussed, is reset. Processing then terminates in operation 940.

The benefit resulting from the present invention is that a transmitting node is assured that a receive node has adequate space available to it to receive a message transmitted. Further, a simple mechanism is provided so that the detection of a lost message may be made by a receiving node. Using the present invention it is possible to minimize the overhead involved in transmitting messages and determining the loss of a message.

While we have shown and described only a few examples herein, it is understood that numerous changes and modifications as known to those skilled in the art could be made to the example embodiment of the present invention. Therefore, we do not wish to be limited to the details shown and described herein, but intend to cover all such changes and modifications as are encompassed by the scope of the appended claims.

We claim:

1. A method of transmitting and receiving messages in a network, comprising:
transmitting a flow control message header to a transmitting node from a receiving node, wherein the flow control header comprises a message sent field and a message limit field;
transmitting a message from the transmitting node to the receiving node and incrementing a send counter;
receiving the message by the receiving node and incrementing a consumed credits variable;
determining a message was dropped when the message sent field is less than or equal to the value of the consumed credits variable;
adjusting the message limit field to compensate for the dropped message; and
transmitting the message limit field to the transmitting node.

2. The method recited in claim 1, wherein the determining a message was dropped further comprises:
setting a variable drop count equal to the message sent field less the consumed credits variable;
determining if the variable drop count is less than an available credits variable, wherein the available credits variable represents the total amount of space allocated to receive messages from a particular node; and
increasing the message limit field value and transmitting the flow control message header to the transmitting node.

3. The method recited in claim 2, further comprising:
setting a new credits variable equal to the available credits variable plus the new credits; and
setting the available credits variable to zero.

4. The method recited in claim 3, further comprising:
setting a send limit variable equal to the message limit field; and
executing a threshold module.

5. The method recited in claim 4, wherein the threshold module further comprising:
determining if the available credits variable is less than a credit threshold variable; and
transmitting the flow control message header to the transmitting node.

6. The method recited in claim 1, further comprising:
transmitting at a predetermined time interval the flow control message header to the transmitting node, wherein a value contained in the message limit field is increased.

7. The method recited in claim 6, wherein the increase in the message limit field further comprises:
incrementing send counter and the message sent field;
incrementing and available credits variable by a new credits variable, wherein the available credits variable represents the total number of messages the transmitting node may send and the new credits variable represents additional messages that may be transmitted by the transmitting node; and
setting the message limit field equal to the consumed credits variable plus the available credits variable.

8. The method recited in claim 1, further comprising:
determining if a get credit variable is set to true, wherein the get credit variable represents that additional messages may be sent by the transmitting node to the receiving node; and
incrementing the available credits variable by the number of additional messages permitted.

9. An apparatus comprising a data storage medium for storing instructions when executed by a processor results in, comprising:
transmitting a flow control message header to a transmitting node from a receiving node, wherein the flow control header comprises a message sent field and a message limit field;
transmitting a message from the transmitting node to the receiving node and incrementing a send counter;
receiving the message by the receiving node and incrementing a consumed credits variable;
determining a message was dropped when the message sent field is less than or equal to the value of the consumed credits variable;
adjusting the message limit field to compensate for the dropped message; and
transmitting the message limit field to the transmitting node.

10. The apparatus recited in claim 9, wherein the determining a message was dropped further comprises:
setting a variable drop count equal to the message sent field less the consumed credits variable;
determining if the variable drop count is less than an available credits variable, wherein the available credits variable represents the total amount of space allocated to receive messages from a particular node; and
increasing the message limit field value and transmitting the flow control message header to the transmitting node.

11. The apparatus recited in claim 10, further comprising:
setting a new credits variable equal to the available credits variable plus the new credits variable; and
setting the available credits variable to zero.

12. The apparatus recited in claim 11, further comprising:
setting a send limit variable equal to the message limit field; and
executing a threshold module.

13. The apparatus recited in claim112, wherein the threshold module further comprising:
determining if the available credits variable is less than a credit threshold variable; and
transmitting the flow control message header to the transmitting node.

14. The apparatus recited in claim 9, further comprising:
transmitting at a predetermined time interval the flow control message header to the transmitting node, wherein a value contained in the message limit field is increased.

15. The apparatus recited in claim 14, wherein the increase in the message limit field further comprises:
incrementing send counter and the message sent field;
incrementing and available credits variable by a new credits variable, wherein the available credits variable represents the total number of messages the transmitting node may send and the new credits variable represents additional messages that may be transmitted by the transmitting node; and
setting the message limit field equal to the consumed credits variable plus the available credits variable.

16. The apparatus recited in claim 9, further comprising:
determining if a get credit variable is set to true, where in the get credit variable represents that additional messages may be sent by the transmitting node to the receiving node; and
incrementing the available credits variable by the number of additional messages permitted.

17. A system for transmitting and receiving messages in a network, comprising:
a receive done module to determine that all message transmitted have been received based upon a flow control header, wherein the flow control header comprises a message sent field and a message limit field; and
a post send module to update an available credits variable, wherein the available credits variable indicates the total number of messages a transmitting node may send to a receiving node.

18. The system recited in claim 17, wherein the receive done module increments a consumed credits variable and compares the consumed credits variable to the message sent field to determine if a message has been dropped.

19. The system recited in claim 18, wherein the receive done module will add an additional value to the message limit field when it is determined that a message has been dropped.

20. The system recited in claim 19, further comprising:
a threshold check module to determine if the transmitting node has any available credits remaining and updating the message limit field to include additional credits when no further credits remaining for the transmitting node.

21. The system recited in claim 19, further comprising:
a post receive module to increment a new credit variable and process pending message requests.

22. The system recited in claim 19 , further comprising:
a periodic update module to determine at a predetermined time interval if a transmitting node has run out of credits used to transmit messages with.
